(19) United States
(12) Patent Application Publication
(10) Pub. No.: US 2010/0027015 A1
(43) Pub. Date: Feb. 4, 2010

(54) Optical sensor

(76) Inventors: Detlef Schweng, Weinstadt-Schnait (DE); Juerg Stahl, Winterthur (CH)

Correspondence Address: KRIEGSMAN & KRIEGSMAN, 30 TURNPIKE ROAD, SUITE 9, SOUTHBOROUGH, MA, 01772, US

(21) Appl. No.: 12/460,582

(22) Filed: Jul. 21, 2009

(30) Foreign Application Priority Data
Jul. 21, 2008 (DE) 10 2008 034 194.0
Oct. 6, 2008 (DE) 10 2008 050 109.3

(51) Int. Cl. G01N 21/59; G01N 21/00

(52) U.S. Cl. 356/437; 356/432

(57) ABSTRACT

The invention relates to an optical device with at least one radiation source (11), a detector (16), a light guide (12) for the primary radiation and a light guide (17) for further conducting the radiation to be detected to detector (16), wherein the light guide (12) for the primary radiation and the light guide (17) for further conducting the radiation to be detected are each designed in such a way that the radiation emitted at the end (13) of the primary light guide (12) on the sample side, after passage through the sample under investigation, falls directly on the end (18) of the light guide (17) on the sample side for further conducting the radiation to be detected.

### CROSS-REFERENCE TO RELATED APPLICATIONS

The present application claims priority under 35 U.S.C. 119 of German Application No. 10 2008 034 194.0, filed Jul. 21, 2008, and German Application No. 10 2008 050 109.3, filed Oct. 6, 2008, both of which are incorporated herein by reference.

### BACKGROUND OF THE INVENTION

The present invention relates to a sensor for conducting optical measurements, particularly in liquids and gases.

Such sensors can be used, for example, in order to determine the change of an indicator by means of absorption spectroscopy in a titration. Also, such sensors can be used in principle for the measurement of radiation losses due to dispersion or for luminescence investigations.

The sensors comprise a light source, a detector and at least two light guides.

The light guides for the primary light serve for the purpose of conducting the primary light produced by the light source into the solution to be investigated. The light guide for the light to be detected serves for the purpose of guiding to the detector a portion of the primary light which is changed, in particular weakened, relative to intensity or wavelength, as a consequence of the passage of the primary light through a layered element containing the liquid or gaseous sample, for example, by absorption, scattering or luminescence.

An optical sensor having two straight, rod-like light guides is known in the prior art for conducting absorption measurements in the UV/VIS region. The two light guides are aligned parallel to one another along their longitudinal axes and are introduced into the solution under investigation from the top by their two ends on the sample side. The ends on the sample side, through which the light exits from the primary light guide and enters into the light guide for the light to be detected, form a planar surface, which is aligned orthogonal to the longitudinal axis of the light guide.

Several mirrors are disposed underneath the ends of the two light guides on the sample side and are adjusted in such a way that the primary light passes through the solution to be investigated onto the mirror and from the latter passes through the solution again onto the second light guide for the light to be detected, in order to then be guided again onto the detector by means of total reflection.

The light guides together with the detector and the light source as well as the mirror arrangement are thus connected rigidly with one another.

A disadvantage in this optical sensor is that contaminants from the solution deposit on the mirrors and also the sensor can be cleaned only with difficulty, since a simple rinsing does not really clean the mirror or the emitting surfaces and a residual amount of rinsing agent remains behind and dries on the mirror or on a place where the light streams through. Thus residues of the solution under investigation or lime residues remain, for example, and this adversely affects the result of the next measurement.

### SUMMARY OF THE INVENTION

The object of the present invention consists of providing an optical sensor which is less contaminated, is easily cleaned and is maintenance-friendly.

The object is achieved by an optical device with at least one radiation source, a detector, a light guide for primary radiation and a light guide for further conducting the radiation to be detected to the detector, whereby the light guide for primary radiation and the light guide for further conducting the radiation to be detected are designed in such a way that the radiation emitted from the end of the primary light guide on the sample side, after passage through the sample under investigation, falls directly on the end of the light guide on the sample side for further conducting the radiation to be detected.

Due to the fact that the radiation emitted from the end of the primary light guide on the sample side passes through the sample under investigation and then falls directly on the end of the light guide on the sample side for further conducting the radiation to be detected, i.e., without deflection via one or more external mirrors found in the sample solution, the dirtying of the external mirrors known from the prior art will be avoided and the sensors are maintenance-friendly and easy to clean.

In a preferred first embodiment, the direct passage of the primary radiation from the primary light guide through the sample onto the end of the light guide on the sample side for the light to be detected is achieved in that the light guide for the primary radiation and the light guide for the radiation to be detected each comprise a mirror on their ends on the sample side, and the two light guides with their mirrors are disposed so that a part of the primary beam irradiated into the sample space from the primary light guide via the mirror, after crossing through a path segment s in the sample space, falls on the second light guide and is extensively conducted to the detector via the mirror on the detector light guide via the detection light guide.

Since the mirrors are integrated in the light guide, the detector according to the invention can be cleaned simply by rinsing off; the washing fluid runs down the light guides and drips down from the ends of the light guides on the sample side or from the mirror, so that significant contaminants cannot deposit on the light guides or on the mirrors.

In this way, increasing contamination of the mirrors during use is avoided; the sensor according to the invention is maintenance-friendly.

A rod-like and straight form of the light guide is advantageous, since the necessary geometric conditions can thus be achieved in a space-saving manner, by selecting a parallel arrangement of the light guides relative to one another and the two mirrors are integrated in the end region of the light guides at a suitable angle to the perpendicular. This embodiment is also characterized by being easy to manipulate.

A mirror is disposed at the end of the primary light guide on the sample side, and this mirror serves for the purpose of deflecting light moving in the lengthwise direction of the light guide, which is totally reflected in the light guide, so that it exits through the sheath surface of the light guide, thus orthogonal to the longitudinal axis of the light guide.

At the sample-side end, each of the two light guides has a planar or curved surface, which—coated with a suitable material—forms the mirror.

For example, silver or aluminum can be used as a coating material.

A maximum intensity of the light to be detected can be attained if the light guides have the same length, end on one plane relative to the perpendicular, and the mirror surfaces on the sample-side end are each tilted by approximately an angle of 45° to the longitudinal axis of the light guide and are coated with a metal layer.

Of course, a sufficiently intense signal at the detector can be obtained also under other angles of inclination a for a corresponding different adjustment or with curved, particularly concave mirrors.

In order to increase the intensity of the primary beam and the beam to be detected, in another preferred embodiment, it is provided that the light guides have a planar or concave surface in the region of their ends on the sample side, which are aligned substantially orthogonal with respect to the principal direction of the primary light beam after striking the mirror or relative to the principal direction of the detection light beam prior to striking the mirror for the detection light. In this way, a further expansion of the light beam is counteracted at the otherwise rounded sheath surface of the light guide.

In the case of a light guide in the form of a round glass rod, the planar surface is achieved by planar grinding of a portion of the sheath surface, and in the case of a light guide in the form of a parallelepiped, by a simple alignment of a planar lateral surface.

A certain bundling of the primary beam and detection light beam is provided by these planar surfaces.

For measurements in more aggressive sample solutions, it has been shown advantageous to protect the mirrors at the light guides by suitable, essentially transparent devices.

These devices are advantageously transparent casings, completely closed on the sample side, particularly made of glass, quartz glass, plastic, etc. It is particularly advantageous to use a straight glass tube, particularly sleeve-shaped, which is closed on the bottom, in which the respective light guide, which is also straight, is inserted simply from the top.

The casing can be fastened to the light guide by means of welding, using adhesives, [or as] a form-fitting and/or frictionally engaged connection.

In order to prevent losses of intensity in the light guide, an air-filled or gas-filled gap is preferably found between the light guide and the casing. The light guide and the casing thus do not lie directly “on top of one another”, so that a reduction in total reflection is prevented.

This casing protects the sensitive mirrors from attack by aggressive chemicals.

In order to prevent a further expansion of the radiation and thus a loss of light, the casing has a surface on its end on the sample side, preferably in the region in which the direction of the principal radiation of the primary radiation reflected via the primary light mirror exits from the light guide and impinges on the outer sheath surface of the casing, this outer surface preventing a further expansion of the primary light beam on the otherwise rounded sheath surface. This surface is preferably planar and concave and aligned essentially orthogonal to the primary incidence direction of the reflected primary radiation.

In the case of the planar or concave surface for the bundling of radiation on the end of the sheath surface of the casing, it is not necessary that the light guide itself also has such a surface on its end on the sample side for bundling the radiation.

In a second embodiment, the light guides are curved in their end region on the sample side such that the front surfaces of the two light guides are disposed essentially opposite one another. For planar front surfaces, these are disposed preferably parallel to one another.

In principle, the front surfaces may also be curved in order to better bundle the incoming and outgoing radiation.

The light guides are preferably rod-shaped in their region that is not on the sample side and are disposed straight and parallel to one another and have a curvature of, for example, 90° or 180°, following a circular segment, in their region on the sample side; therefore, the radiation is deflected in the light guide by an angle γ of 90° in its upper region relative to the direction of radiation.

In the case of an essentially semicircular curvature in the lower region, the light guides are preferably aligned parallel to one another in the region of uptake device 27, at a distance which approximately corresponds also to the path s of the radiation through the solution under investigation. At its end on the sample side, each of the two light guides has an approximately semicircular curvature, whereby the direction of radiation is deflected by an angle γ of 90°.

As a consequence of the semicircular curvature, both light guides are outwardly convexly curved on their ends on the sample side, so that this embodiment is characterized by a greater width of the sensor in the end region on the sample side.

It is also possible that the straight light guides disposed preferably parallel to one another in the upper region follow approximately a circular segment with an angle of 90° (a quarter circle) at the end on the sample side. In this case, the distance between the two light guides relative to one another is increased at the end that is not on the sample side and the front surfaces of the two light guides in the end region on the sample side lie opposite one another and parallel to one another, as long as the front surfaces are planar, due to this curvature.

In general, round or square-section glass rods have proven to be particularly suitable light guides, round glass rods being particularly suitable.

In principle, light guides made of glass, quartz glass, plastic or another optically transparent material can be produced for the respective wavelength.

The two light guides are preferably attached by their ends that are not on the sample side in an uptake device and are attached in such a way that a quantity of light to be detected that is still sufficient for the sensitivity of the detector falls into the detector light guide via the two light guides and, optionally, the mirrors; i.e., light that is weakened and/or modified as a consequence of passage through the path element s in the solution, and is conducted from there into the detector optionally via the mirror therein, and after input of the totally reflecting primary light via the primary light mirror into the solution under investigation.

The intensity of the primary light source, the orientation and distances of the light guides or their front surfaces relative to one another, optionally the size of the mirrors and their alignment relative to one another and relative to the light guides, as well as possible radiation losses in the light guide must be fine-tuned to one another so that the detector signal still can be a signal of sufficient intensity for the type of solution under investigation (extinction, scattering behavior, etc.).

Different light sources, both monochromatic as well as polychromatic light sources, such as LEDs, lamps, lasers, (N)IR light sources, UV lamps, incandescent lamps or gas discharge lamps, for example, can be connected to the primary light guide, as a function of the sample under investigation and the required intensity of the primary radiation.

Due to their size and their price, LEDs are particularly suitable for routine examination of titrations by means of absorption spectroscopy.

For the sensor according to the invention, radiation detectors of any type may be used, for example, photodiodes, photomultipliers, photocells or diode arrays—each time depending on the type of radiation that is to be detected and that remains the same or is changed after passage through the solution under investigation.

The sensors may have an uptake device for the light source and the detector, in which the ends of the light guide that are not on the sample side are also attached.

### BRIEF DESCRIPTION OF THE DRAWINGS

The invention will be described in more detail below on the basis of embodiment examples. Herein is shown:

FIG. 1 a schematic view of a first embodiment of the sensor without casing,

FIG. 2 an enlarged schematic view of FIG. 1 in the region of the end of the light guide on the sample side.

FIG. 2a a section through the light guide along line B in the direction of arrow A in FIG. 2,

FIG. 3 another preferred embodiment of a sensor, in which the light guides are provided with a casing,

FIG. 3a a section through the light guide and the casing along line B in the direction of arrow A in FIG. 3,

FIG. 4 a schematic view of a second embodiment of the sensor with a 180° curvature and

FIG. 5 a schematic view of a second embodiment of the sensor with a 90° curvature.

### DETAILED DESCRIPTION OF THE INVENTION

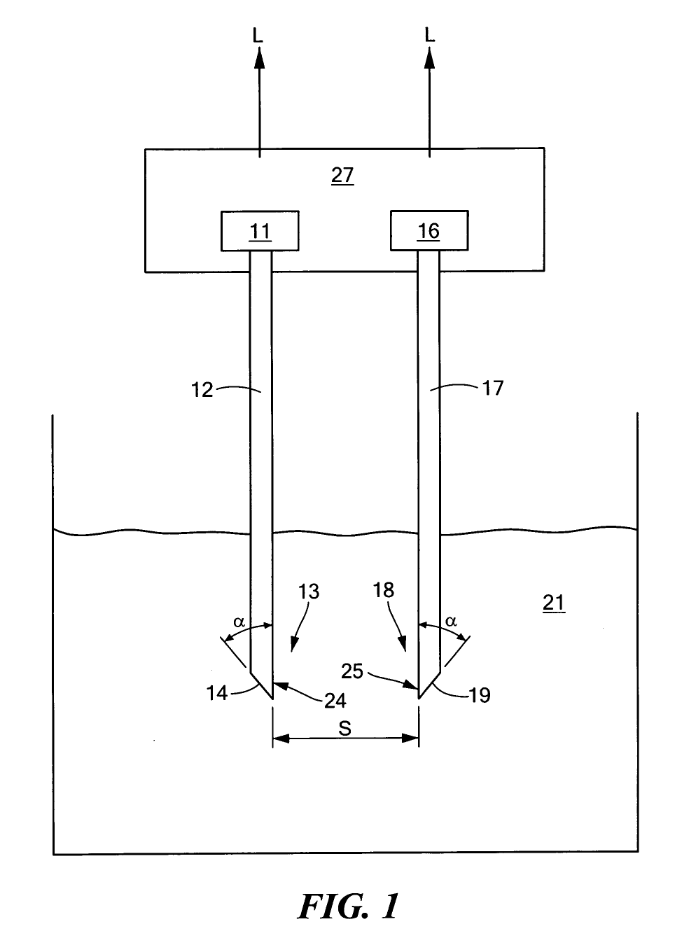

The sensor according to FIG. 1 comprises two light guides 12, 17, a light source 11 and a detector 16. Both light guides 12, 17 are rod-shaped and straight and their longitudinal axes are disposed parallel to one another. The ends of light guides 12, 17 that are not on the sample side are attached together in an uptake device 27 in radiation source 11 and in detector 16.

Light guide 12 serves for further conducting the radiation produced in radiation source 11 into the solution under investigation found in sample space 21.

The radiation striking the light guide 17 from the solution is conducted further to detector 16 through light guide 17.

The two light guides 12, 17 each have a mirror 14, 19 on the ends 13, 18 on the sample side. The mirror is a part of the light guide and is produced by depositing a thin layer of metal on an appropriately oriented, planar or curved surface at the end of the light guide.

In this embodiment, the mirror surfaces 14, 19 are planar and are inclined at an angle α of 45° relative to the longitudinal axis L of light guides 12, 17.

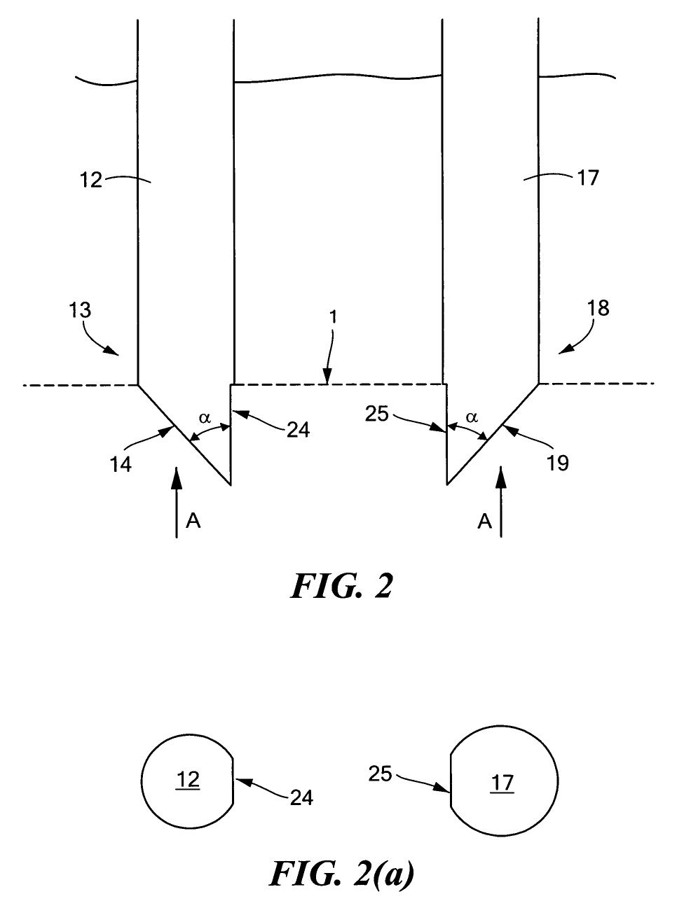

The primary light falling on mirror 14 from light source 11 via light guide 12 is reflected at mirror 14 and then exits from the light guide via the outside surface of light guide 12 (see FIG. 2).

In the case of a light guide 12, 17 in the form of a round glass rod, in order to prevent an expansion of the beam exiting from light guide 12, 17, due to the curvature of the outside surface, a surface 24, 25 is provided in each case in this embodiment near the ends 13, 18 of the light guide on the sample side, and this surface contributes to the solution for the bundling of the primary light beam or of the light beam to be detected during passage [through] light guides 12, 17, and is found approximately at the level of mirror 14, 19.

These planar surfaces 24, 25 can be produced by grinding in the lower region of light guides 12, 17.

The planar surfaces 24, 25 should preferably be aligned relative to the adjacent mirrors 14, 19, so that surfaces 24, 25 are aligned essentially orthogonal relative to the direction of the principal ray of the primary beam or the detection-light beam before or after striking on mirrors 14, 19.

The beam that has passed through the bundling surface 24 now passes through path segment s in the solution, whereby the beam is weakened. As the beam to be detected, a part of the beam now strikes light guide 17 connected to detector 16 and via mirror 19 and then strikes detector 16 as a consequence of total reflection.

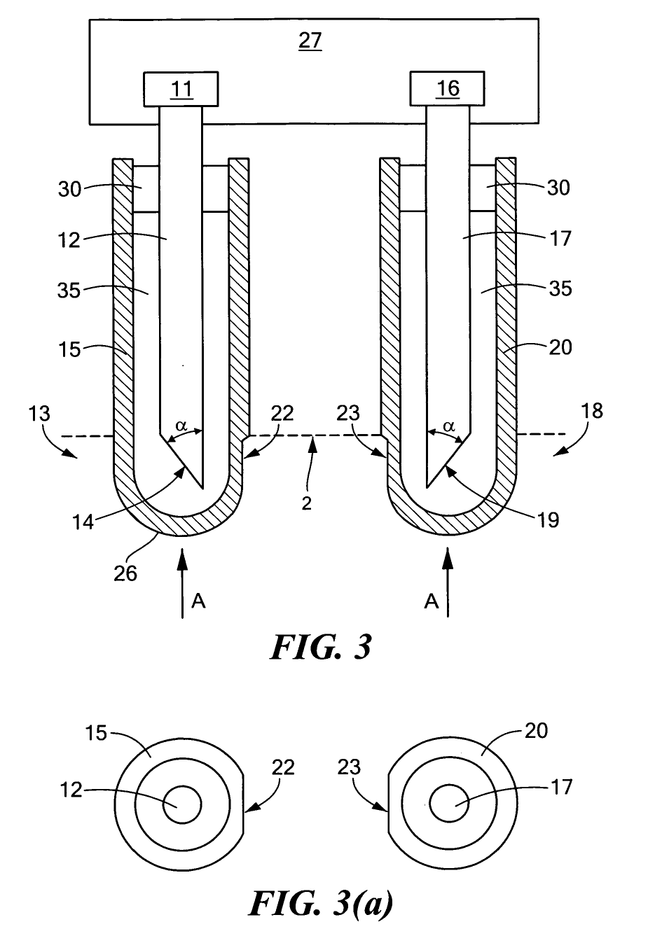

The sensors according to another preferred embodiment described in FIG. 3 are particularly suitable for use in more aggressive liquids.

These sensors comprise the two light guides 12, 17 with mirrors 14, 19, which have already been described above, a light source 11, a detector 16 and uptake device 27.

The two light guides 12, 17 are each surrounded by a tube-shaped glass tube 15, 20, which is sealed at its lower end 26 and serves as a casing, so that the liquid to be investigated cannot penetrate into the region of the light guide with the sensitive mirror on the sample side. Light guides 12, 17 are inserted into glass casings 15, 20 and attached by means of an adhesive connection 30.

A gap 35 filled with gas or air between light guides 12, 17 and casings 15, 20 prevents losses that would adversely affect the total reflection.

In order to obtain a focusing of the primary light reflected by mirror 14, the casings preferably also have a planar or concavely curved bundling surface 22, 23 on their ends 13, 18 on the sample side on the outside of casings 15, 20, in order to avoid a further expansion of the radiation emitted from light guide 12 via mirrors 14, 19 or input into light guide 17 and thus to avoid an intensity loss.

In embodiments in which the casings 15, 20 have surfaces 22, 23 for bundling the radiation, another bundling surface 24, 25 provided on light guides 12, 17 is generally not necessary.

It is understood that mirrors 14, 19 and planar surfaces 22, 23 of casings 15, 20 should be adjusted to maximum light intensity.

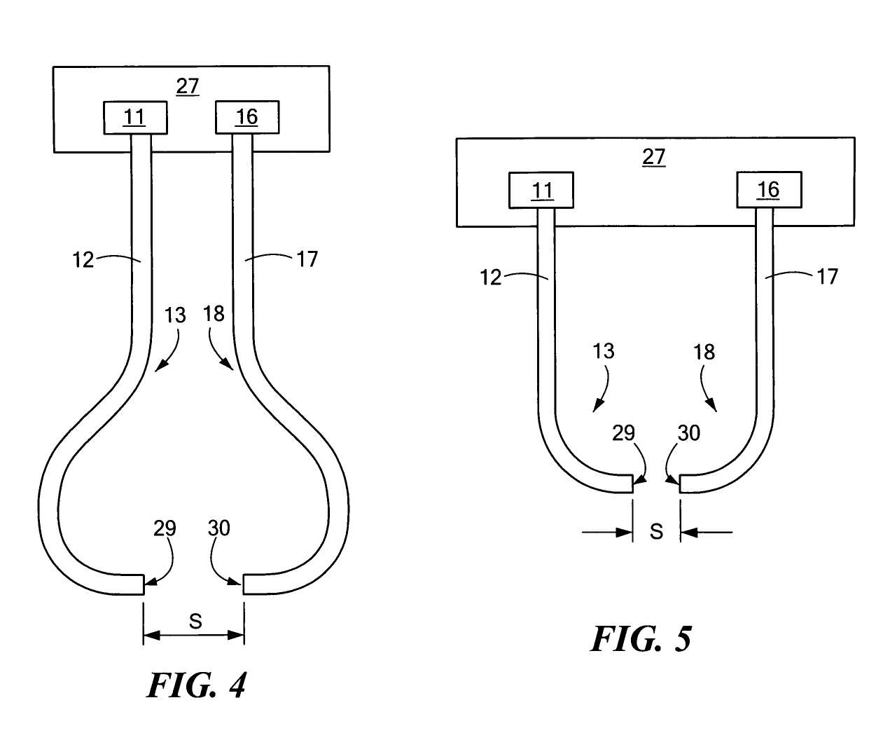

Light guides according to two preferred embodiments are shown in FIGS. 4 and 5. Unlike the sensors according to the first preferred embodiment with mirrors on the ends of the light guides on the sample side, the deflection of radiation is produced in these embodiments by a suitable curvature of light guides 12, 17 in the regions 13, 18 on the sample side.

The curvature is thus designed so that the respective front sides 29, 30 of the two light guides 12, 17 are disposed opposite one another at their ends 13, 18 on the sample side, so that after exiting from the front surface 29 of the primary light guide 12 and passage through the path segment s in solution 21 under investigation, a large part of the primary radiation falls on the front surface 30 of light guide 17 for the light to be detected and then is conducted further via light guide 17 to detector 16.

The radiation can be deflected according to FIG. 4, for example, by an essentially semicircular curvature (180°), or according to FIG. 5, by an essentially quarter-circle curvature (90°).

The two light guides 12, 17 are shaped outwardly convex in their end regions 13, 18 on the sample side, in the case of a 180° curvature. In the upper region, the two light guides are disposed parallel to one another and at not too great a distance from one another and are taken up in uptake device 27.

In the case of the alternative 90° curvature shown in FIG. 5, the distance of the light guides relative to one another is increased in the upper region, i.e., the entire uptake device 27 has a greater width.

In addition to the embodiments shown in FIGS. 4 and 5, the radiation can be deflected through curvature of the light guide, of course, also by other forms of curvature.

In designing the curvatures, all curvatures that are too sharp or angular should be avoided, since this can lead to falling below the critical angle of total reflection in the light guide.

For this reason, it follows that the curvature in FIG. 4 also does not follow a true half-circle. Rather, the transition of the curvature into the straight region flows smoothly.

1. An optical device with at least one radiation source, a detector, a light guide for primary radiation and a light guide for further conducting the radiation to be detected to detector is hereby characterized in that the light guide for primary radiation and the light guide for further conducting the radiation to be detected are each designed in such a way that the radiation emitted at the end of the primary light guide on the sample side, after passage through the sample under investigation, falls directly on the end of the light guide on the sample side for further conducting the radiation to be detected.

2. The optical device according to claim 1, further characterized in that the light guide for the primary radiation and the light guide for the radiation to be detected each comprise a mirror on their ends on the sample side, and the two light guides with their mirrors are disposed in such a way that at least a part of the primary beam irradiated by the primary light guide via mirror into sample space, after crossing through a path segment s in sample space, falls on the second light guide, and the radiation to be detected is extensively conducted to detector via mirror.

3. The device according to claim 1, further characterized in that the light guides are rod-shaped and straight.

4. The device according to claim 1, further characterized in that the longitudinal axes of the two light guides are disposed parallel to one another.

5. The device according to claim 2, further characterized in that on their ends on the sample side, light guides have metal-coated surfaces serving as mirrors.

6. The device according to claim 2, further characterized in that mirrors are planar or concave.

7. The device according to claim 2, further characterized in that the mirrors are made of a metal layer, particularly of silver or aluminum.

8. The device according to claim 2, further characterized in that light guides have surfaces in the region of their ends on the sample side, which are aligned essentially orthogonal with respect to the principal direction of the primary light beam after striking mirror or with respect to the principal direction of the detection light beam prior to striking mirror.

9. The device according to claim 8, further characterized in that surfaces are planar or concave.

10. The device according to claim 2, further characterized in that each light guide is surrounded by a casing, which shields light guides and mirrors relative to the solution to be measured.

11. The device according to claim 10, further characterized in that casings surround light guides like a sleeve.

12. The device according to claim 10, further characterized in that the casing is fastened to the light guide by means of welding, using adhesives or as a form-fitting and/or frictionally engaged connection.

13. The device according to claim 12, further characterized in that casings have surfaces in the region of their ends on the sample side, which are aligned essentially orthogonal with respect to the principal direction of the primary light beam after exiting from light guide or with respect to the detection light beam prior to striking light guide.

14. The device according to claim 13, further characterized in that surfaces are planar or concave.

15. The device according to claim 10, further characterized in that casings and/or light guides are made of glass, quartz glass, plastic or another optically transparent material for the respective wavelength.

16. The device according to claim 10, further characterized in that air or a gas is found between light guides and casings.

17. The device according to claim 1, further characterized in that in their end regions on the sample side, light guides are curved in such a way that the front surfaces of the two light guides are disposed essentially opposite one another.

18. The device according to claim 17, further characterized in that front surfaces are essentially disposed parallel to one another.

19. The device according to claim 17, further characterized in that front surfaces are straight or convex.

20. The device according to claim 17, further characterized in that the curvature of light guides in their end regions essentially follows a circular segment of 90° or 180°.

21. Use of a device according to claim 1 for conducting absorption measurements for titrations.
